(19) United States
(12) Patent Application Publication
(10) Pub. No.: US 2024/0227340 A1
(43) Pub. Date: Jul. 11, 2024

(54) Method for Operating a Press, Computer Program and Electronically Readable Data Carrier

(71) Applicant: Bayerische Motoren Werke Aktiengesellschaft, Muenchen (DE)

(72) Inventors: Bernhard GLUECK, Fuerstenfeldbruck (DE); Ingo HEINLE, Inzell (DE); Christian SCHEIDIG, Dingolfing (DE)

(21) Appl. No.: 18/558,774

(22) PCT Filed: Jun. 10, 2022
(86) PCT No.: PCT/EP2022/065829

§ 371 Date: Nov. 3, 2023

(30) Foreign Application Priority Data
Jul. 6, 2021 (DE) 10 2021 117 346.9

(51) Int. Cl. B30B 15/26; B21C 51/00; B21D 22/02; B30B 15/30; G06V 30/12; G06V 30/19

(52) U.S. Cl. CPC B30B 15/26; B21C 51/00; B21D 22/02; B30B 15/30; G06V 30/133; G06V 30/19; G05B 2219/2622; G06V 2201/06

(57) ABSTRACT

Methods, systems, and apparatuses are provided for operating a press in which circuit boards are reshaped. The circuit boards each have a unique serial number. An electronic computing device stores measured values characterizing the associated circuit board for the respective serial number. A capture device in a feed area in which the circuit boards are fed into the press is used to produce images of the serial number. A recognition unit is used to recognize the serial numbers in the images. A recognition rate is determined.

### BACKGROUND AND SUMMARY

The present subject matter relates to a method for operating a press according to the preamble of patent claim 1. The present subject matter also relates to a computer program according to patent claim 9. Finally, the present subject matter relates to an electronically readable data carrier according to patent claim 10.

DE 10 2015 221 417 A1 shows multiple methods. One of the methods is used to provide singularized material parts from a web-like semifinished product, wherein at least one parts parameter of the strip-like semifinished product is determined with regional accuracy, the material parts are singularized from the web-like semifinished product and are provided with an individual identifier, and the individual identifiers of the singularized material parts are provided in combination with the respectively determined at least one parts parameter. Another method is used to process singularized material parts, wherein individual identifiers of singularized metal parts are provided in combination with at least one respective parts parameter determined therefor, a respective individual identifier of the material parts is read off, the singularized material parts are processed to form respective prefabricated parts and the individual identifiers of the prefabricated parts are provided in combination with respective processing parameters.

In this way, single sheet metal parts or in particular metal blanks are cut from coils in coil plants in the prior art. Material parameters and/or material properties that characterize the blank are measured for these blanks and stored with an identification number for the blank. The blank is then processed further. In addition to the material parameters and/or material properties of the blank, parameters that characterize machining steps, for example when shaping the blank to produce a prefabricated part, can be recorded by means of the serial number or identification number in this case. In addition, information about the quality of the prefabricated part, for example in the form of inspector's results, can also be recorded.

The object of the present subject matter is to provide a method, a computer program and an electronically readable data carrier that allow a press processing the blank to be operated particularly advantageously.

This object is achieved according to the present subject matter by the subjects of the independent patent claims. Advantageous embodiments of the present subject matter are the subject of the dependent patent claims, the description and the drawing.

A first aspect of the present subject matter relates to a method for operating a press. The press is in particular in the form of a shaping press and/or cutting press. The press is used to machine blanks, in particular cut blanks, in particular to shape them by pressing. The respective blank has a respective unique serial number. This number is applied by means of laser engraving methods when cutting the blank from a coil in a coil plant, for example. An electronic computing device is used to hold characterizing measured values for the respective serial number and therefore the respective blank, such as a material thickness of the blank as ascertained in the coil plant. The serial number may be a sequent number and can be represented alphanumerically and/or by means of a barcode or QR code, for example.

So that the press can now be operated particularly advantageously, the method according to the present subject matter has provision for a capture device, for example a camera, to be used to take photographs of the, in particular entire, serial number in an introduction region in which the blank is introduced into the press in particular for machining, in particular shaping. That is to say that every blank that has a serial number is captured by the photograph. A recognition unit, for example of the electronic computing device, then and/or simultaneously brings about recognition of the serial number in the photographs. In other words, an attempt is made to identify or decipher the recorded serial number so that further parameters, in particular relating to process steps in the press, can be assigned to said serial number in the electronic computing device, for example, so as to allow a particularly advantageous production process, for example. The recognition by the recognition unit can be implemented for example by means of a machine vision algorithm, for example an OCR algorithm. A recognition rate that in particular characterizes how many of the serial numbers captured in particular by the photographs are recognized is then determined for the method according to the present subject matter on the basis of the recognition. The determination of the recognition rate allows for example an action recommendation for maintaining a particularly robust production process to be output, as a result of which the press can be operated particularly advantageously. As such, the action recommendation that is output can be for example adjustment of the parameters for the laser engraving or the reading cameras and/or a cleaning job for the maintenance department.

The present subject matter is based on the insight that the cutting of the blanks and the subsequent processing in the press are independent process steps, for example during the manufacture of vehicle prefabricated parts made from the blanks in motor vehicle production. Recorded data from the two process steps of cutting the blank and machining in the press are advantageously used for deriving action recommendations. In addition, data regarding a prefabricated part quality can also be used for deriving the action recommendation. As such, for example process parameters from both processing steps and the properties of the associated blank are measured by the electronic computing device. To this end, in order to make the assignment, the blanks are labelled with the sequent number or the serial number in particular during cutting, for example in the coil plant.

The blanks are cut in particular from what is known as a coil, that is to say a wound metal strip. The individual coil may be oiled, in particular, and therefore the blank cut therefrom is likewise oiled. To make the serial number or sequent number durable, therefore, these are produced by means of laser engraving methods in particular when cutting the blank from the coil. If the blank has a zinc layer, for example, this is roughened only slightly, for example, in the process, so that, if an outer skin prefabricated part later emerges from the blank, the laser engraving could also be inserted at a point that is visible from the outside without impairing a possibly applied lacquer and while completely preserving the corrosion protection of the zinc layer.

All data associated with the respective blank can now be stored in a database of the electronic computing device, for example, on the basis of the serial number. When processing the blanks in the press or during insertion into the press, this serial number or sequent number is read by means of the recognition device, in particular a camera. This camera or recognition device is arranged in front of the first press or in a press line. As such, the press can be a single press or an entire press line.

Multiple data, for example process parameters that emerge during the processing of the blank in the press line or press, can then also be filed in the database under the captured and recognized serial number on the basis of the serial number. The data from both process steps, the cutting and the subsequent processing in the press, can therefore be combined by means of the serial number described.

A crucial step in this context is the recognition of the serial number in the introduction region of the press.

Cameras and the associated image processing software may not comprehensively recognize all serial numbers, the blanks processed in the press. However, a high recognition rate is a basic prerequisite for particularly advantageous usability of the entire press. An impairment of the recognition rate should thus be recognized as quickly as possible therefore.

The term module (and other similar terms such as unit, subunit, submodule, etc.) in the present disclosure may refer to a software module, a hardware module, or a combination thereof. Modules implemented by software are stored in memory or non-transitory computer-readable medium. The software modules, which include computer instructions or computer code, stored in the memory or medium can run on a processor or circuitry (e.g., ASIC, PLA, DSP, FPGA, or other integrated circuit) capable of executing computer instructions or computer code. A hardware module may be implemented using one or more processors or circuitry. A processor or circuitry can be used to implement one or more hardware modules. Each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices and stored in memory or non-transitory computer readable medium.

The recognition rate for the serial numbers can be dependent for example on the texture, the type of material, the labelling quality and the orientation of the blank when reading the sequent number in the introduction region. Furthermore, camera and/or lighting settings and an orientation of the blank can influence the recognition rate.

A random inspection of the recognition rate may take place manually during or after the completion of a production order. A production order is for example a production cycle in the press in which for example a B pillar is produced from one type of blank, for example. Another production order can involve the press being fitted with new tools and therefore producing for example B pillars or other components of the vehicle from a different type of blank, for example.

For example, a demand on the recognition rate per production process in this case is dependent on the type of blank, and for example is 97 percent. However, there may also be types of blanks in which for example the properties of the coil plant or the like mean that not all blanks can be labelled, and so for example only two of three blanks are labelled with the serial number, in which case a recognition rate of just 65 percent is called for. A manual random inspection naturally causes significant effort. Furthermore, the disadvantage of random inspections is that a lowering of recognition rates, for example during a production cycle or for one type of blank, could remain undetected, entailing a negative effect on the operation of the press.

The method according to the present subject matter is therefore based on the concept of automatically measuring the recognition rate for all types of blanks, assessing it and in particular additionally also transferring the recognition rate to a monitoring instance, whether of human and/or machine type, of the press, for example. The method thus allows objective statistical assessment. This assessment by the method according to the present subject matter takes place adaptively for example by comparing the currently ascertained recognition rate with recognition rates from the past. The monitoring instance may be people and/or systems, for example a maintenance department, plant personnel and/or a central office.

In other words, the method may be designed in particular such that the current recognition rate compared with a recognition rate from the past is ascertained and, if said recognition rate falls in comparison with the past, for example, a warning is automatically output for example to the monitoring instance. As such, continuous monitoring allows a distribution of the recognition rate in the past to be ascertained, for example also depending on the product, and, on that basis, for example a lower limit or a lower first limit value and/or a lower further limit value to be automatically derived, in particular on the basis of statistical methods. If the current recognition rate falls short of this lower limit value, a warning can be output. The method thus allows manual upkeep of limit values to be avoided, since the limit values are ascertained automatically.

Since the recognition rate can change in both directions, in principle, the statistically ascertained limit values are ascertained in particular only for a defined time window, for example. As a result, for example the first or every further limit value for the recognition rate reflects a recognition rate from the near past, for example. Should the recognition rate rise, for example, the lower limit value should also rise in the near future. Were in particular all available data from the past to be used, a lower limit value would rise only after many further newly ascertained recognition rates if many recognition rates ascertained in the past were present, for example. In principle, it is nevertheless possible to temporarily exclude individual types or kinds of blanks from the inspection, and/or to erase the recognition rates from the past, should this be necessary, by means of a manual intervention or control option, such as by maintaining a created list. By way of example, the quality of the labelling or serial number can also be impaired due to a known change of supplier of the semifinished product, in particular the coil.

The method is advantageously carried out in such a way that the inspection of the recognition rate for the respective capture device of the press is implemented separately, in particular if multiple capture devices are produced in the case of a press in the form of a press line. The recognition rate in this case is advantageously determined for example by way of a machine learning method or algorithm. As such, for example the learning algorithm looks up what has been found for the same prefabricated part or the same blank in the past, allowing the new recognition rate to be classified as appropriate.

The method results in the advantage that manual effort for a random check on the recognition rate can be dispensed with. Furthermore, the advantage obtained is objective assessment of the recognition rate. This results in further advantages, such as early recognition of the fall in recognition rates for individual types of blanks. Another advantage realized can be monitoring of all types of blanks in different production orders or production cycles. The method according to the present subject matter therefore allows active warning in the event of impairment of the recognition rate, which can allow particularly advantageous operation of the press. In addition, the method also affords the advantage of recognizing systematic changes particularly quickly and objectively. A systematic change would be for example if the recognition rates for the semifinished product of a supplier and/or a specific texture changes.

In one advantageous embodiment of the present subject matter, the recognition rate is determined by comparing the recognized serial numbers against the number of blanks introduced into the press. In other words, the recognition rate is determined in a particularly simple way. As such, the number of serial numbers correctly recognized by the recognition unit, which are held in the electronic computing device, for example, is divided by the known number of pieces of the blanks that are introduced into the press and processed there. This results in the advantage that the method can be carried out particularly easily and therefore for example particularly efficiently.

In another advantageous embodiment of the present subject matter, the recognition rate is continuously determined during a production cycle. In other words, during a production order during which for example a specific number of one type of blank is shaped to produce another type of prefabricated part, the recognition rate is determined not only at the end of the production cycle but rather for each blank introduced, for example. Continuous monitoring of the recognition rate can therefore be realized, as a result of which the press can be operated particularly advantageously.

In another advantageous embodiment of the present subject matter, a warning signal or an information signal is output if the recognition rate diverges from a first limit value, which for example, as described above, can be defined by a distance from a limit value from the past. In particular, the warning signal can be output by the electronic computing device and/or on a display device, for example. Furthermore, the first limit value can be predefined by the computing device and/or on the basis of earlier recognition rates automatically and/or manually, for example on the basis of the list. In other words, a warning signal or a warning is provided, in particular to a monitoring instance. This results in the advantage that the press can be operated in a particularly failsafe manner.

In another advantageous embodiment of the present subject matter, a change in the recognition rate over time is measured. In other words, a time characteristic of the recognition rate and therefore the recognition rate for a specific time or for a defined time interval is determined and measured. This results in the advantage that the press can be operated particularly advantageously.

In another advantageous embodiment of the present subject matter, the recognition rate is compared with at least one recognition rate from an earlier production cycle. In other words, a recognition rate ascertained in the past during a further production order, but in particular with the same type of blank, is compared with the currently measured recognition rate. This allows the press to be operated in a particularly advantageous way.

In another advantageous embodiment of the present subject matter, a further limit value is ascertained on the basis of the comparison of the recognition rates and/or the change in the recognition rate, in particular over time. The further limit value can be used as a basis for the subsequent production cycle or cycles. In other words, the first limit value can be predefined for example manually by a user of the press; the further limit value can be ascertained or determined in particular by way of a self-learning algorithm or the like that is implemented on an electronic computing device, for example. The advantage obtained is particularly fast detection of a change in the recognition rate. Furthermore, another advantage may be automated adjustment of reading parameters, such as change of lighting, change of position of the camera. Additionally, the advantage can arise that the press can be operated with particularly little user intervention.

In another advantageous embodiment of the present subject matter, the divergence of the recognition rate in particular from the first limit value is determined, the change is determined and/or the comparison is made by means of machine learning and/or by way of at least one statistical method. The first limit value can likewise be ascertained by means of machine learning and/or by way of at least one statistical method. The machine learning can be implemented by means of a self-learning algorithm, for example. Additionally or alternatively, the machine learning can be realized by way of a neural network, for example. In addition, a combination of the self-learning algorithm with a neural network is conceivable. The machine learning is produced in particular by way of a self-learning system that acquires the algorithm and/or the neural network, for example. This results in the advantage that the press can be operated in such a way that interventions by users can be particularly advantageously reduced.

A second aspect of the present subject matter comprises a computer program. The computer program can be loaded into a memory of an electronic computing device of a press, for example, and comprises program means in order to perform the steps of the method when the program is executed in the electronic computing device or a control device of the conveyor system.

Another aspect of the present subject matter relates to an electronically readable data carrier. The electronically readable data carrier comprises electronically readable control information stored thereon that comprises at least one computer program as just presented or is configured in such a way that it can carry out a method as presented here when the data carrier is used in an electronic computing device of a press.

Advantages of the method can be regarded as advantages of the computer program and of the electronically readable data carrier, and vice versa in each case.

Further features of the present subject matter will become apparent from the claims, the figures and the description of the figures. The features and combinations of features cited in the description hereinabove and the features and combinations of features cited in the description of the figures hereinbelow and/or shown in the figures alone can be used not only in the respectively indicated combination but also in other combinations or on their own.

### BRIEF DESCRIPTION OF THE DRAWINGS

FIG. 1 shows a schematic flowchart for a method for operating a press designed to shape blanks in combination with cutting of the blanks in a coil plant; and

FIG. 2 shows a schematic flowchart of the method for operating the press.

### DETAILED DESCRIPTION OF THE DRAWINGS

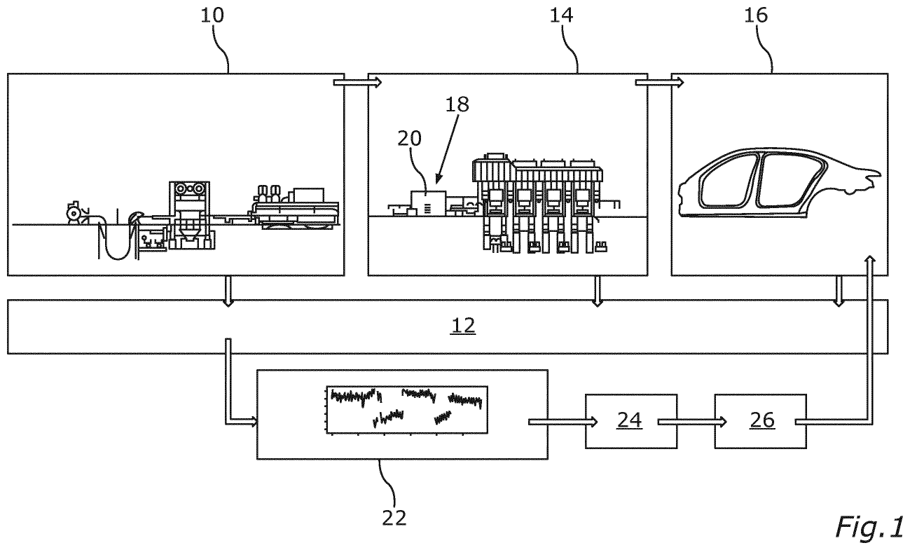

FIG. 1 uses a schematic flowchart to show a production method from the semifinished product to a prefabricated part of a motor vehicle. As such, a coil plant 10 in which blanks are cut from a coil, a metal strip or semifinished product, is schematically shown. The single blank is provided with a serial number or sequent number in the coil plant 10, for example by means of laser engraving, each blank receiving a unique serial number.

The serial number is filed in an electronic computing device 12, for example. Additionally, for example a memory area of the electronic computing device 12 is used to also file measured values characterizing the respective blank or material parameters and/or material properties for the serial number, such as for example mechanical properties, a surface roughness, sheet thickness, an oil layer thickness and/or additionally or alternatively process parameters relating to the coil plant 10. The aforementioned data or material parameters and/or material properties are therefore combined with the serial number in the electronic computing device 12.

Furthermore, a press 14 that can comprise one or more presses in a press line and is used for shaping, in particular by means of pressing, the blanks is schematically shown. Shaping or pressing the respective blank allows for example a prefabricated part 16 of a motor vehicle to be produced, which is in the form of a bodywork part, for example. Arranged in an introduction region 18 of the press 14 there may be a capture device 20, in particular in the form of a camera, that is designed to capture the serial numbers of the blanks. Alternatively, there may also be provision for multiple cameras or capture devices 20.

Cutting the blanks by means of the coil plant 10 can be a first process step in the manufacture of the prefabricated part 16. It is then possible, in a further process step, processing, in particular by means of shaping, in the press 14, to measure further parameters, in particular process parameters, for the serial number. These process parameters can be filed by or by means of the electronic computing device 12 for example in a memory area of the electronic computing device 12. The process parameters can be for example setting parameters for the press, the press bed, ambient temperature, humidity, forces acting on the blank as a result of the press, et cetera.

Following the production process, it is also possible for example to measure the prefabricated part quality for the prefabricated part 16 produced from the blank, resulting data likewise being able to be acquired or stored for the associated serial number by means of the electronic computing device 12. The measurement or storage of the material parameters and/or material properties, the process parameters and the prefabricated part quality is shown in FIG. 1 by each of the three arrows that reach the electronic computing device 12.

The electronic computing device 12 can implement process modelling, for example, that is shown by the graph 22. As such, the material parameters, material properties and/or process parameters combined with the respective serial numbers and a resultant prefabricated part quality can be taken as a basis for outputting a forecast quality 24, for example, that allows process control 26 that can directly influence the prefabricated part quality, a respective influence being indicated by arrows in FIG. 1.

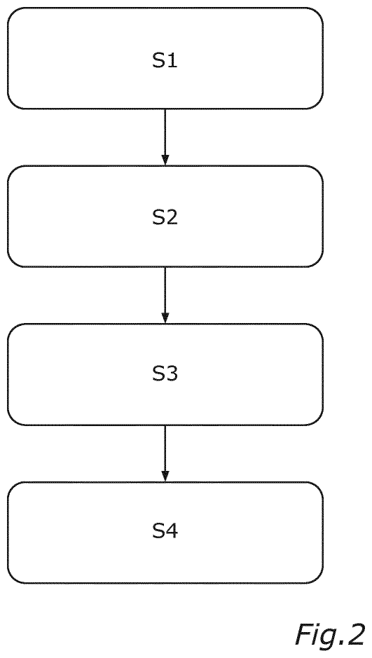

So that the forecast quality 24 and therefore the process control 26 can now be implemented particularly advantageously and therefore in particular the press 14 can be operated particularly advantageously, FIG. 2 uses a schematic flowchart to show a method that comprises multiple steps. In this case, the method is used to operate the press 14 in which the blanks, which each have a unique serial number, are shaped, the electronic computing device 12 being used to hold measured values characterizing the associated blank for the respective serial numbers, as was in particular already shown in FIG. 1.

The steps of the method in detail:

In a first step S1, the capture device 20 is used to produce a photograph of the serial number in the introduction region 18 in which the blanks are introduced into the press 14.

In a second step S2, a recognition unit, which for example is an appropriate algorithm of the electronic computing device 12, is used to recognize the serial numbers in the photographs.

Finally, in a third step S3, a recognition rate that characterizes how many of the recorded serial numbers have actually been recognized and can therefore be identified for further processing in the electronic computing unit 12, for example, is determined.

The three steps S1 to S3 mentioned can be used to carry out the method for operating the press 14. In an additional step S4, an action recommendation, in particular for example for maintaining a robust production process, can be output, for example. As such, for example in step S4, a warning signal can be output if the recognition rate diverges from a first limit value, for example. The first limit value can be predefined, for example also manually, for example by machine learning by means of the electronic computing device 12 and/or for example for a first production cycle and/or a new startup of the press 14. A manual default, in particular if each of the blanks has a serial number engraved in particular by way of laser engraving, of 97 percent can be predefined in this case, for example.

The recognition rate can advantageously be determined by comparing the recognized serial numbers against the number of blanks introduced into the press 14. In this case, the recognition rate is continuously determined in particular additionally or alternatively advantageously during a production cycle. The production cycle is for example a production order in which one type of blank is used for the manufacture of an A pillar of a motor vehicle, for example, the press 14 being fitted with appropriate tools or shaping tools in this case. One production cycle or production order in this case can therefore mean for example the production of 1000A pillars from 1000 blanks. Another production cycle or production order can mean or describe for example the manufacture of 2000B pillars from a different type of blank by means of another shaping tool or tool set with which the press 14 is equipped. It is therefore a further advantage if the recognition rate is compared with at least one recognition rate from an earlier production cycle, for example possible expected quality losses in the finished prefabricated part 16 can already be detected early and therefore the press 14 can be operated particularly advantageously.

It is therefore also particularly advantageous if a change in the recognition rate over time is measured or this can advantageously be determined in order to be able to statistically assess a time characteristic of the production process in particular objectively. A further limit value can advantageously be ascertained in addition to the first limit value, this being able to take place in particular by means of machine learning in particular on the basis of the comparison and/or the change over time.

The self-learning algorithm can be executed for example in the electronic computing device 12 and/or on a neural network designed specifically therefor, which may likewise be a component of the electronic computing device 12.

Steps S1 to S3 and in particular S1 to S4 of the method can advantageously be performed by a computer program that can be loaded directly into a memory of a memory device, for example the electronic computing device 12, of the press 14, in a separate IOT PC and/or in a central IT architecture, such as of a cloud-based solution. Program means in this case may be suitable for performing steps S1 to S4 of the method when the program is executed in the computing device 12 or a control device of the press 14. May additionally be held on an electronically readable data carrier with electronically readable control information stored thereon if at least one computer program is included and configured to perform steps S1 to S3 or S1 to S4 of a method presented here when the data carrier is used in a control device of a press 14.

The method shown allows automatic and individual or product-related monitoring of the recognition rate for serial numbers on blanks in press lines in a particularly advantageous manner.

### LIST OF REFERENCE SIGNS

10 coil plant
12 electronic computing device
14 press
16 prefabricated part
18 introduction region
20 capture device
22 graph
24 forecast quality
26 process control
S1 first step
S2 second step
S3 third step
S4 fourth step

1.-10. (canceled)

11. A method for operating a press, wherein
blanks that have a respective unique serial number are machined,
an electronic computing device is used to hold measured values characterizing the blank associated with the respective serial number, and
the method comprises:
producing, using a capture device, photographs of the serial number in an introduction region in which the blanks are introduced into the press,
recognizing, using a recognition unit, the serial numbers in the photographs, and
determining a recognition rate.

12. The method according to claim 11, wherein determining the recognition rate comprises:
comparing the recognized serial numbers against the number of blanks introduced into the press.

13. The method according to claim 11, wherein
the recognition rate is continuously determined during a production cycle.

14. The method according to claim 11, further comprising:
outputting a warning signal is output in response to the recognition rate diverging from a first limit value.

15. The method according to claim 11, further comprising:
measuring a change in the recognition rate over time.

16. The method according to claim 11, further comprising:
comparing the recognition rate with at least one recognition rate from an earlier production cycle.

17. The method according to claim 15, further comprising:
ascertaining a further limit value based on the change.

18. The method according to claim 15, further comprising:
determining, using machine learning and/or at least one statistical method, a divergence and the change.

19. The method according to claim 16, further comprising:
determining, using machine learning and/or at least one statistical method, a divergence and the comparison.

20. A non-transitory computer-readable medium comprising instructions operable, when executed by the electronic computing device, to:
perform the steps of the method according claim 11, when the instructions are executed in the electronic computing device and connected to the press.
